(19) United States
(12) Patent Application Publication
(10) Pub. No.: US 2026/0312138 A1
(43) Pub. Date: Oct. 8, 2026

(54) ELECTRODE ASSEMBLY AND SECONDARY BATTERY INCLUDING THE ELECTRODE ASSEMBLY

(71) Applicant: SAMSUNG SDI CO., LTD., Yongin-si (KR)

(72) Inventor: Hyun Woo KIM, Yongin-si (KR)

(21) Appl. No.: 19/308,599

(22) Filed: Aug. 25, 2025

(30) Foreign Application Priority Data
Apr. 4, 2025 (KR) 10-2025-0043804

(51) Int. Cl. H01M 10/0583; B60L 50/64; H01M 4/36; H01M 4/62; H01M 10/052

(52) U.S. Cl. CPC H01M 10/0583; H01M 4/366; H01M 4/623; H01M 10/052; B60L 50/64; H01M 2220/20

(57) ABSTRACT

An electrode assembly includes a first electrode plate including a plurality of folding sections and a plurality of stacked first stacking sections. Each of the folding sections connects two adjacent first stacking sections and each of the first folding sections includes a plurality of through-holes. The electrode assembly also includes a second electrode plate including a plurality of second stacking sections, each of the stacking sections being disposed between two adjacent first stacking sections.

### CROSS-REFERENCE TO THE RELATED APPLICATION

The present application claims priority to and the benefit of Korean Patent Application No. 10-2025-0043804, filed on Apr. 4, 2025, in the Korean Intellectual Property Office, the entire disclosure of which is incorporated herein by reference.

### BACKGROUND

### 1. Field

Aspects of some embodiments of the present disclosure relate to an electrode assembly and a secondary battery including the electrode assembly.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

The present disclosure describes an electrode assembly in which through-holes are formed in an electrode plate, thereby improving a stacking process when forming a battery, and a secondary battery including the electrode assembly. For example, the present disclosure may provide a structure in which through-holes are formed in a portion of the electrode plate to facilitate folding. This structure may enable smooth folding of the electrode plate and may facilitate alignment of the plate, thereby reducing errors that may occur during a process of stacking electrode plates. Further, by designing the folding section in an interlocking form similar to a hinge, the folding curvature may be reduced, and stacking may be more efficiently achieved compared to conventional structures.

The present disclosure may enhance the durability of the electrode plate and compensate for structural weaknesses resulting from folding by applying a patterned coating with high binder content to a fold region. This approach may simplify the battery manufacturing process, maximize space utilization, and increase the mechanical strength of the electrode plate.

These and other aspects and features of the present disclosure will be described in or will be apparent from the following description of embodiments of the present disclosure.

An electrode assembly for a secondary battery according to an embodiment of the present disclosure includes a first electrode plate including a plurality of folding sections and a plurality of stacked first stacking sections, each of the folding sections connecting two adjacent first stacking sections and each of the folding sections including a plurality of through-holes, and a second electrode plate including a plurality of second stacking sections, each of the second stacking sections being disposed between two adjacent first stacking sections.

According to some embodiments, the first electrode plate may include a conductive substrate, a first active material layer coated on the conductive substrate, and a second active material layer coated on the first active material layer. The first active material layer may be coated in the folding sections, and the first and second active material layers may be coated in the first stacking sections.

According to some embodiments, the first active material layer may include a first binder, the second active material layer may include a second binder, and the concentration of the first binder may be higher than that of the second binder.

According to some embodiments, each of the first and second binders may include an aqueous binder or an organic binder.

According to some embodiments, each of the first and second binders may include carboxymethyl cellulose (CMC), styrene-butadiene rubber (SBR), polytetrafluoroethylene (PTFE), or polyvinylidene fluoride (PVDF).

According to some embodiments, the through-holes formed in each of the folding sections may extend through the first active material layer and the first conductive substrate.

According to some embodiments, the through-holes may be formed in triangular, circular, elliptical, square, rectangular, pentagonal, hexagonal, rhombic, or cross shapes, and the through-holes may be arrayed in a matrix form in each of the folding sections.

According to some embodiments, the folding sections and the first stacking sections in the first electrode plate may include a Z-shape or an S-shape.

According to some embodiments, the electrode assembly may further include a separator interposed between the first stacking sections and the second stacking sections.

According to some embodiments, the total area of the through-holes in each of the folding section may be 40% to 90% of the area of each of the folding sections.

An electrode assembly for a secondary battery according to an embodiment of the present disclosure for accomplishing the above aspects includes a first electrode plate, a second electrode plate, and a separator disposed between the first and second electrode plates, wherein the first electrode plate, the second electrode plate, and the separator disposed between the first and second electrode plates are wound in a jelly roll form, at least one of the first electrode plate or the second electrode plate includes a plurality of folding sections, and each of the folding sections includes a plurality of through-holes.

According to some embodiments, at least one of the first electrode plate or the second electrode plate may include a conductive substrate, a first active material layer coated on the conductive substrate, and a second active material layer coated on the first active material layer. The first active material layer may be coated in the folding sections, and the first and second active material layers may be coated in sections other than the folding sections.

According to some embodiments, the first active material layer may include a first binder, the second active material layer may include a second binder, and the concentration of the first binder may be higher than that of the second binder.

According to some embodiments, each of the first and second binders may include an aqueous binder or an organic binder.

According to some embodiments, each of the first and second binders may include carboxymethyl cellulose (CMC), styrene-butadiene rubber (SBR), polytetrafluoroethylene (PTFE), or polyvinylidene fluoride (PVDF).

According to some embodiments, the through-holes formed in each of the folding sections may extend through the first active material layer and the conductive substrate.

According to some embodiments, the through-holes may be formed in triangular, circular, elliptical, square, rectangular, pentagonal, hexagonal, rhombic, or cross shapes, and the through-holes may be arrayed in a matrix form in each of the folding sections.

According to some embodiments, the electrode assembly may be wound in a form having long sides and short sides.

According to some embodiments, the total area of the through-holes in each of the folding sections may be 40% to 90% of the area of each of the folding sections.

A secondary battery according to an embodiment of the present disclosure for accomplishing the above aspects includes the electrode assembly described above.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIGS. 1 and 2 are a perspective view and an exploded perspective view showing a pouch-type battery according to an embodiment of the present disclosure;

FIG. 3 is a cross-sectional view showing an electrode assembly of the pouch-type battery according to the embodiment of the present disclosure;

FIGS. 4 and 5 are enlarged cross-sectional views showing a folding section of an electrode plate according to the embodiment of the present disclosure;

FIG. 6 is a view showing a method of manufacturing the electrode plate in the electrode assembly according to the embodiment of the present disclosure;

FIG. 7 is a view showing various shapes and arrangement patterns of through-holes formed in the folding section of the electrode plate according to the embodiment of the present disclosure;

FIGS. 8 and 9 are a perspective view and a cross-sectional view of a prismatic battery according to an embodiment of the present disclosure;

FIG. 10 is a cross-sectional view showing the electrode assembly according to the embodiment of the present disclosure;

FIG. 11 is a perspective view showing a battery module according to an embodiment of the present disclosure;

FIGS. 12 and 13 are perspective views showing a battery pack including the secondary battery according to some embodiments; and

FIGS. 14 and 15 are perspective and side views showing a vehicle including aspects of an example battery pack according to some embodiments.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be arranged in contact with the upper (or lower) surface of the element, and another element may also be interposed between the element and the arbitrary element located on (or under) the element.

In addition, it will be understood that when a component is referred to as being “linked,” “coupled,” or “connected” to another component, the elements may be directly “coupled,” “linked” or “connected” to each other, or another component may be “interposed” between the components“.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the present disclosure.

In general, a stacked battery is made by sequentially stacking a plurality of electrode plates. During the stacking process, issues such as alignment errors, space inefficiency due to a folding curvature, and complexity in the manufacturing process may arise. For example, in a conventional Z-stacking method, a single separator may be used; however, it is difficult to efficiently stack a positive electrode plate and a negative electrode plate due to the folding curvature of the separator. The present disclosure is directed to overcoming the limitations of conventional stacking methods.

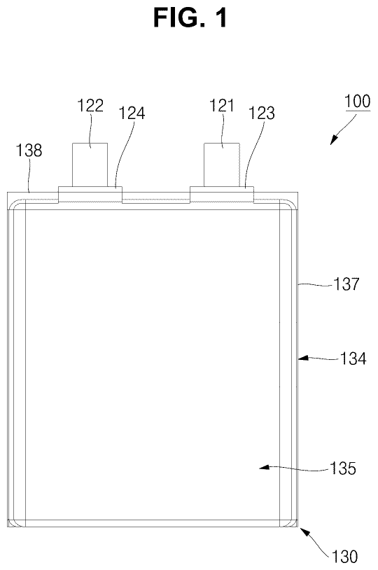

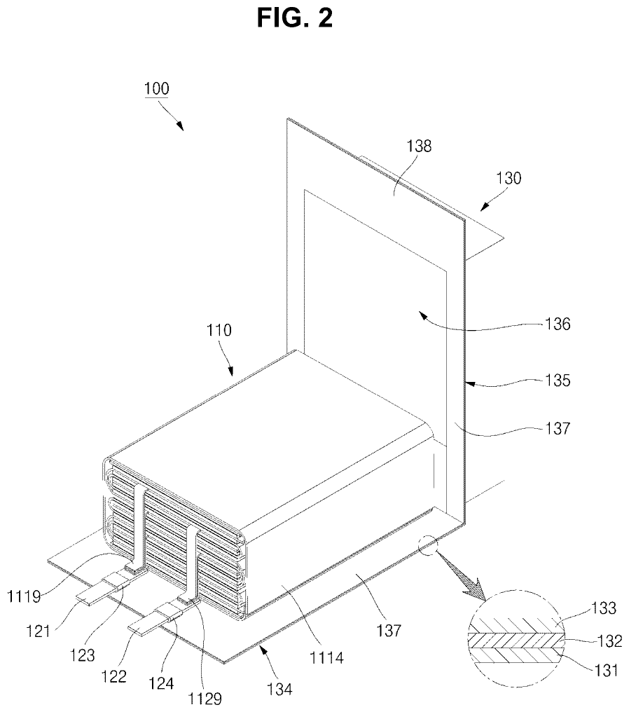

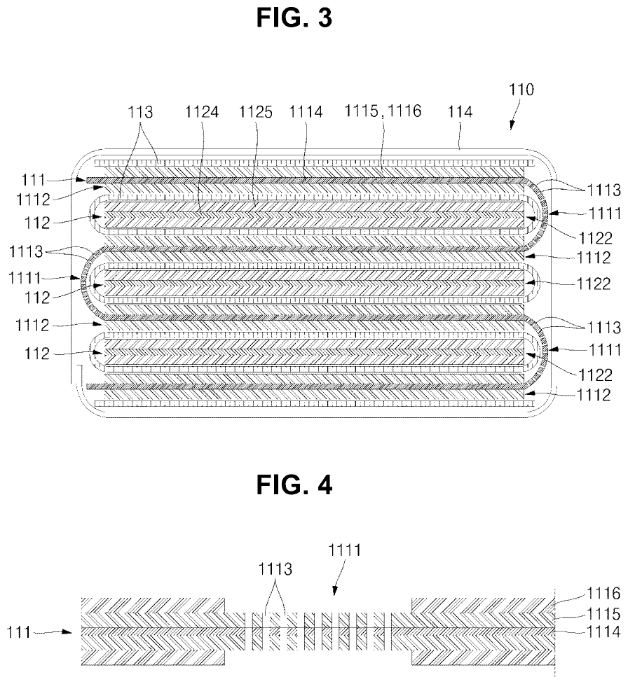

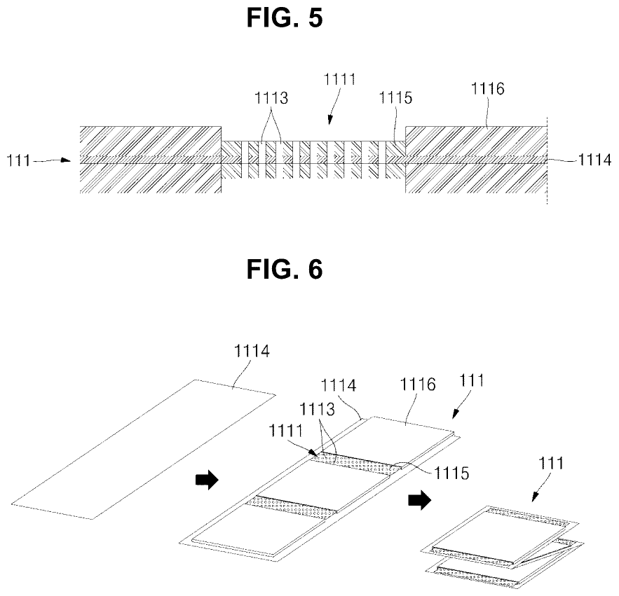

FIGS. 1 and 2 are a perspective view and an exploded perspective view showing a pouch-type battery 100 according to an embodiment of the present disclosure. FIG. 3 is a cross-sectional view showing an electrode assembly 110 of the pouch-type battery 100 according to the embodiment of the present disclosure. FIGS. 4 and 5 are enlarged cross-sectional views showing a folding section 1111 of an electrode plate 111 according to the embodiment of the present disclosure. It should be noted that in FIGS. 4 and 5 the folding section 1111 is shown in a flat state rather than in an actually folded state.

In FIGS. 1 to 5, the pouch-type battery 100 according to the embodiment of the present disclosure includes an electrode assembly 110 and a case 130. The battery 100 further includes a first electrode tab 121 and a second electrode tab 122 for electrical connection.

The electrode assembly 110 may include a first electrode plate 111, a second electrode plate 112, and a separator 113 interposed between the first and second electrode plates 111 and 112.

The first electrode plate 111 may include a plurality of folding sections 1111 and a plurality of first stacking sections 1112 that are stacked. The first electrode plate 111 may be folded in, for example, a Z-shape or S-shape. This configuration may contribute to maximizing space utilization and increasing the density of the electrode plate.

Each folding section 1111 may be configured to interconnect two adjacent first stacking sections 1112. The folding section 1111 may include a plurality of through-holes 1113 to facilitate bending. In the depicted example, two adjacent stacking sections 1112 are located at an upper position and a lower position in the electrode assembly 110 and are connected to each other via the folding section 1111.

The first electrode plate 111 may function as a positive electrode plate or a negative electrode plate. The first electrode plate 111 may include a first conductive substrate 1114, a first active material layer 1115 coated on the first conductive substrate 1114, and a second active material layer 1116 coated on the first active material layer 1115.

As shown in FIG. 4, only the first active material layer 1115 may be coated in the folding section 1111, whereas both the first and second active material layers 1115 and 1116 may be coated in each of the first stacking sections 1112. In an example, the first active material layer 1115 may first be coated over the entire area of the first conductive substrate 1114, and then the second active material layer 1116 may be coated on the first active material layer 1115 in the sections other than the folding section 1111.

The first conductive substrate 1114 may further include a first substrate tab 1119 that extends outward by a predetermined length without an active material layer coated thereon, and the first substrate tab 1119 may be welded to the first electrode tab 121. This configuration may facilitate electrical connection of the electrode plate.

In a secondary battery, an active material plays a critical role in storing and releasing electrical energy, and a binder may be used to maintain the structural stability of an electrode plate containing the active material. The binder serves as an adhesive that connects various particles used in the electrode plate (e.g., active material particles or conductive additives) and helps the particles adhere to a conductive substrate (e.g., a current collector). Without the binder, the particles in the electrode plate may be separated or non-uniformly distributed, whereby electrical performance may deteriorate.

The first active material layer 1115 may include a first binder, and the second active material layer 1116 may include a second binder. The first and second binders may include the same material or different materials.

The concentration of the first binder may be higher than that of the second binder. Because the concentration of the first binder in the first active material layer 1115 is relatively high, the adhesion between the first active material layer 1115 and the first conductive substrate 1114 may be enhanced, thereby improving the durability of the first electrode plate 111. If the first active material layer 1115 is firmly fixed to the first conductive substrate 1114, it may help reduce damage to the electrode plate and ensure that the second active material layer 1116 functions properly. Because the concentration of the second binder in the second active material layer 1116 is relatively low, conductivity and electrochemical reactivity may be improved. As a result, electrons may move more easily, and the active material may absorb and release a greater number of lithium ions, thereby improving battery performance.

In some embodiments, each of the first and second binders may include an aqueous binder or an organic binder. Each of the first and second binders may include carboxymethyl cellulose (CMC), styrene-butadiene rubber (SBR), polytetrafluoroethylene (PTFE), or polyvinylidene fluoride (PVDF).

When the first electrode plate 111 functions as a positive electrode plate, organic binders such as PVDF may be primarily used. PVDF exhibits high chemical stability in the presence of electrolyte and excellent thermal stability, thereby providing the durability and stability required for positive electrodes of lithium secondary batteries. Because positive electrode active materials typically exhibit oxidative characteristics, organic binders having high chemical stability, such as PVDF, may be suitable.

When the first electrode plate 111 serves as a negative electrode plate, aqueous binders such as CMC or SBR may be primarily used. This is because materials such as graphite, which are commonly used in negative electrodes, may effectively bond with aqueous binders and enable environmentally friendly processing during the manufacturing process. Aqueous binders are cost-effective, offer good processability, and have less environmental impact compared to organic binders. For silicon (Si)-based negative electrode materials, binders having high elasticity, such as SBR, may be suitable to accommodate a high expansion ratio.

When the first electrode plate 111 is a dry electrode plate, fibrillatable binders such as PTFE may primarily be used. PTFE may undergo fibrillation during dry mixing, enabling sufficient binding performance without the use of a solvent.

The folding section 1111 may be provided between the first stacking sections 1112. For example, one folding section 1111 may be provided on a first side of each first stacking section 1112, and another folding section 1111 may be provided on a second side of each first stacking section 1112. Such folding sections 1111 may be provided in a zigzag pattern on both sides of the electrode assembly 110.

The plurality of through-holes 1113 formed in the folding section 1111 may penetrate the first active material layer 1115 and the first conductive substrate 1114. The total area of the through-holes 1113 may be in a range of approximately 40% to approximately 90% of the area of the folding section 1111. In consideration of balance between smooth folding, structural stability, and electrochemical performance of the electrode plate, the total area of the through-holes 1113 formed in the folding section 1111 may be set to be between approximately 40% and approximately 90% of the area of the folding section 1111.

If the total area of the through-holes is less than approximately 40%, the electrode plate may retain high physical stiffness, which may hinder smooth folding. If a sufficient open area is not secured in the folding section, the electrode plate may bend with a larger radius rather than folding smoothly, which may result in an increased stacking interval and reduced space utilization. Further, difficulty in folding may require the application of unnecessary additional force during alignment and assembly in the stacking process, which may increase the complexity of the manufacturing process.

When the total area of the through-holes exceeds approximately 90%, the mechanical strength of the electrode plate may be significantly reduced. Although smooth folding may be achieved, excessive removal of material may physically weaken the electrode plate and increase the likelihood of damage during the stacking process. For example, fatigue cracks may occur or the electrode plate may tear during folding. Such damage may adversely affect the performance consistency of the electrode plate. Furthermore, excessive removal of the active material layer from the electrode plate may reduce the effective area of the electrode, potentially resulting in reduced battery capacity and degraded electrochemical performance of the battery.

As described above, by setting the total area of the through-holes to be between approximately 40% and approximately 90% of the area of the folding section, smooth folding may be achieved while avoiding excessive weakening of the electrode plate. If the total area of the through-holes is approximately 40% or greater, a sufficient open area may be secured to facilitate folding. If the total area of the through-holes is limited to approximately 90% or less, the structural strength of the electrode plate may be maintained while ensuring a certain level of battery performance. Thus, the range of approximately 40% to approximately 90% provides a balance between foldability and structural stability.

As shown in FIG. 5, in other embodiments only the first active material layer 1115 may be coated in the folding section 1111, and only the second active material layer 1116 may be coated in the sections other than the folding section 1111. By separately applying the first and second active material layers 1115 and 1116 to the folding section 1111 and the remaining sections, the coating thicknesses of the active material layers may be more precisely adjusted, the overall thickness uniformity of the electrode plate may be improved, and variations in the manufacturing process may be reduced.

The second electrode plate 112 may have a polarity opposite to that of the first electrode plate 111. For example, if the first electrode plate 111 functions as a positive electrode, the second electrode plate 112 may function as a negative electrode, and if the first electrode plate 111 functions as a negative electrode, the second electrode plate 112 may function as a positive electrode. The second electrode plate 112 may include a plurality of second stacking sections 1122, and each of the second stacking sections 1122 may be disposed between two adjacent first stacking sections 1112.

The second electrode plate 112 may include a second conductive substrate 1124 and an active material layer 1125 coated on the second conductive substrate 1124. The second conductive substrate 1124 may further include a second substrate tab 1129, which is not coated with the active material layer 1125 and extends outward by a predetermined length. The second substrate tab 1129 may be welded to the second electrode tab 122.

The separator 113 may be interposed between the first electrode plate 111 and the second electrode plate 112. According to some embodiments, the separator 113 may surround the first electrode plate 111 or the second electrode plate 112. The separator 113 may include, for example, polyethylene, polypropylene, or a porous copolymer of polyethylene and polypropylene. A ceramic coating may be provided on the surface of the separator 113 to enhance thermal performance. The width of the separator 113 may be greater than the width of the first electrode plate 111 and the width of the second electrode plate 112 in order to prevent electrical short circuit between the first electrode plate 111 and the second electrode plate 112.

The outermost portion of the electrode assembly 110 may be finished with a sealing tape 114 in order to prevent the electrode assembly 110 from being unraveled. The electrode assembly 110 may include, or may be referred to as, a stack, a Z-stack, an electrode group, an electrode body, or a jelly roll.

The case 130 may accommodate the electrode assembly 110 while sealing the outer peripheral edge of the electrode assembly 110. The case 130 may include, or may be referred to as, an exterior member, a pouch, a can, or a housing. According to some embodiments, the case 130 may have a laminate structure including, for example, a first insulating layer 131, a metal layer 132, and a second insulating layer 133. In other embodiments, various adhesive layers or functional layers may be added.

The case 130 may include a first case 134 and a second case 135, with one end of is the second case 135 being connected to the first case 134 and which includes a recess 136 having a predetermined depth to accommodate the electrode assembly 110. The peripheries of the first and second cases 134 and 135 corresponding to the outer peripheral edge of the electrode assembly 110 may be thermally bonded to each other. Thus, the electrode assembly 110 may be accommodated in the case 130, which is substantially of a pouch type or a pocket type.

The case 130 may be divided into the first case 134 and the second case 135 by bending a middle portion of the rectangular plate-shaped integrated case 130 in the longitudinal direction. The recess 136 having a predetermined depth, in which the electrode assembly 110 may be accommodated, may be formed in the second case 135 through a pressing or drawing process. A sealing area 137 for sealing with the first case 134 may be provided along the outer peripheral edge of the recess 136. The sealing area 137 may be provided not only along one side of the case 130 where the first case 134 and the second case 135 are integrally connected, but also along the remaining three sides of the case 130.

According to some embodiments, the case 130 may be formed of stainless steel. Sealing of stainless steel may be performed through laser welding.

As described above, the first substrate tab 1119 of the electrode assembly 110 may be welded to the first electrode tab 121, and the second substrate tab 1129 may be welded to the second electrode tab 122. The first electrode tab 121 and the second electrode tab 122 may extend outward by a predetermined length through the case 130, with first and second insulating tapes 123 and 124 interposed between the first and second electrode tabs 121 and 122 and the case 130, respectively. An area of the case 130 through which the first electrode tab 121 and the second electrode tab 122 extend outward may be referred to as a terrace 138. In some examples, the first electrode tab 121 may be made of aluminum, and the second electrode tab 122 may be made of copper or nickel.

As the positive electrode active material, a compound capable of reversibly intercalating/deintercalating lithium (e.g., a lithiated intercalation compound) may be used. For example, at least one of a composite oxide of lithium and/or a metal selected from cobalt, manganese, nickel, and/or combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<×≤2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer located on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and combinations thereof but is not limited thereto.

The organic material and the inorganic material may be mixed in one coating layer or may be in the form of a coating layer containing an organic material and a coating layer containing an inorganic material that are laminated on each other.

FIG. 6 shows a method of manufacturing the electrode plate 111 in the electrode assembly 110 according to the embodiment of the present disclosure. The process of manufacturing the first electrode plate 111 may include three main steps: (1) providing the first conductive substrate 1114; (2) coating the first and second active material layers 1115 and 1116 and forming the through-holes 1113; and (3) folding the electrode plate 111.

In the step of providing the first conductive substrate 1114, a substantially rectangular first conductive substrate 1114 is prepared. The first conductive substrate 1114 serves as a structural foundation of the electrode plate and provides a base for subsequent coating of active material layers and formation of through-holes.

Subsequently, the step of coating the first and second active material layers 1115 and 1116 and forming the through-holes 1113 is performed. In this step, the first active material layer 1115 may first be uniformly coated over the entire area of the first conductive substrate 1114. Subsequently, the second active material layer 1116 is coated on selected portions of the first active material layer 1115 at predetermined intervals. For example, the second active material layer 1116 may be divided into multiple layers disposed at predetermined intervals, but not covering the entire area of the first active material layer 1115. This configuration may prevent excessive overlap of materials in the folding section of the electrode plate and ensure mechanical flexibility of the electrode plate. The through-holes 1113 are formed in the sections in which the second active material layer 1116 is not formed. The through-holes 1113 may serve to effectively distribute stress generated during folding of the electrode plate, facilitate folding, and maximize space utilization during stacking. The through-holes 1113 may be formed, for example, by mechanical punching or laser beam processing.

Subsequently, in the step of folding the first electrode plate 111, the first electrode plate 111 may be folded in a Z-shape with reference to the section in which the through-holes 1113 are formed. In this configuration, the section including the through-holes 1113 may be defined as the folding section 1111. The folding section 1111 including the through-holes 1113 may have enhanced mechanical flexibility, thereby enabling smooth folding of the first electrode plate 111 while ensuring the structural stability of the first electrode plate 111.

Finally, the second electrode plate 112 is stacked between the first electrode plates 111 folded in a Z-shape, with the separator 113 interposed between the first and second electrode plates 111 and 112. For example, the separator 113 may be disposed between the stacked first electrode plates 111, and the second electrode plate 112 may be stacked with the separator 113 interposed between the first and second electrode plates 111 and 112. By this process, the electrode assembly 110 may be formed. The Z-stack structure utilizing the through-holes may maximize space utilization of the electrode plate.

The manufacturing method of the present disclosure is configured to facilitate folding of the electrode plate and to achieve both mechanical stress distribution and structural stability utilizing the through-holes. Further, by optimizing the arrangement of the first and second active material layers, it is possible to improve the durability of the folded structure while maintaining the electrochemical performance of the electrode plate.

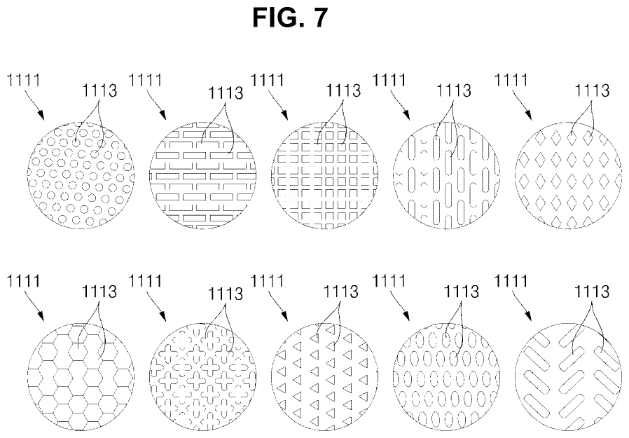

FIG. 7 shows various shapes and arrangement patterns of the through-holes 1113 that may be formed in the folding section 1111 of the electrode plate according to the embodiment of the present disclosure. The through-holes 1113 may be formed in the folding section 1111 to enable smooth deformation of the electrode plate during stacking and folding processes. The shapes and arrangements of the through-holes serve as factors that affect the folding performance and structural stability of the electrode.

The through-holes 1113 may be formed in various shapes such as a triangular, circular, elliptical, square, rectangular, pentagonal, hexagonal, rhombic, or cross shape. These shapes may adjust the mechanical flexibility of the electrode plate and the distribution of stress generated during folding. For example, circular or elliptical through-holes may evenly distribute stress during folding, thereby inducing a uniform deformation pattern. As another example, triangular or square through-holes may concentrate stress in specific directions, thereby inducing a particular deformation pattern depending on the folding method.

In some embodiments, the through-holes 1113 may not be disposed as isolated elements but may be arrayed in a matrix form in the folding section 1111. For example, by arranging the through-holes in a grid pattern aligned according to a rule, it may be possible to induce uniform deformation throughout the folding section 1111 and to achieve smooth folding. The matrix arrangement of the through-holes 1113 may prevent excessive crumpling or tearing of a specific portion of the electrode plate during folding and to maintain the mechanical stability of the electrode plate even under repeated folding.

According to the present disclosure, various shapes of through-holes may be applied to adjust the mechanical characteristics of the folding section, and the arrangement thereof may also be precisely adjusted to maximize the flexibility of the electrode plate while maintaining the structural stability of the electrode plate. This approach may facilitate the stacking and folding processes of the electrode plate, thereby enhancing the reliability of the manufacturing process and improving the durability and performance of the battery.

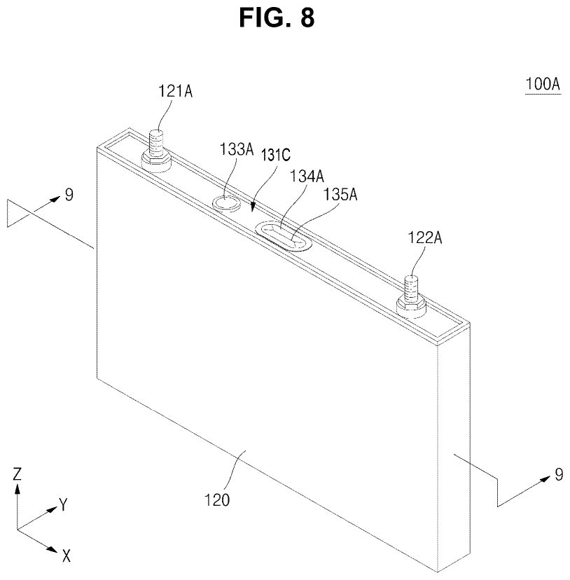

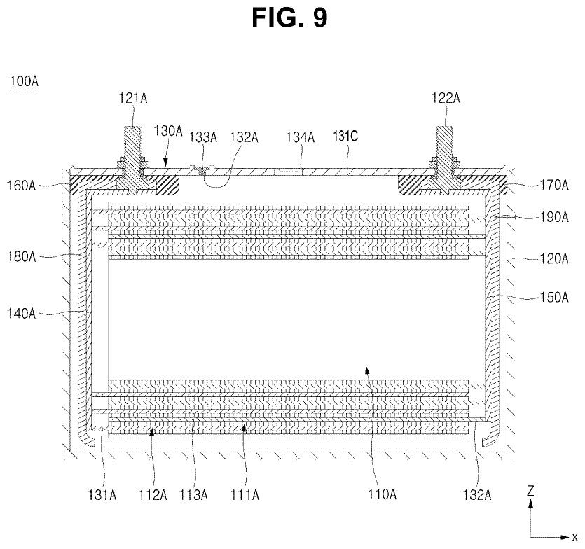

FIGS. 8 and 9 are a perspective view and a cross-sectional view of a prismatic battery 100A according to an embodiment of the present disclosure. FIG. 9 is a cross-sectional view taken along line 9-9 in FIG. 8.

In the example shown in FIGS. 8 and 9, the secondary battery 100A according to the embodiment of the present disclosure may include an electrode assembly 110A, which has a structure similar to that of the above-described electrode assembly 110, a case 120A that accommodates the electrode assembly 110A, and a cap assembly 130A that is coupled to the case 120A to close an opening into the case 120A.

The electrode assembly 110A may include a first substrate tab 131A extending through one side (e.g., left side) thereof and a second substrate tab 132A extending through the other side (e.g., right side) thereof.

The case 120A may define the exterior appearance of the secondary battery 100A, and the case 120A may be formed of a conductive metal, such as aluminum, an aluminum alloy, or nickel-plated steel. The case 120A may provide a space in which the electrode assembly 110A is accommodated.

The cap assembly 130A may include a cap plate 131C that covers the opening of the case 120A, and the case 120A and the cap plate 131C may be formed of a conductive material. In this configuration, negative and positive terminals 121A and 122A, which are electrically connected to a negative electrode plate 111A and a positive electrode plate 112B, may be protrude outward through the cap plate 131C. The first electrode plate may function as a negative electrode plate, and the second electrode plate function as a positive electrode plate.

According to some embodiments, threaded outer circumferential surfaces may be formed on upper portions of the negative and positive terminals 121A and 122A protruding outside the cap plate 131C. In such a case, the negative and positive terminals 121A and 122A may be fastened to the cap plate 131C using nuts. However, the present disclosure is not limited to such a configuration, and the negative and positive terminals 121A and 122A may be implemented, for example, as a rivet structure and coupled to the cap plate 131C by riveting, or the negative and positive terminals 121A and 122A may be welded to the cap plate 131C.

The cap plate 131C may be formed as a thin plate and may be coupled to the case 120A to close an opening into the case 120A. The cap plate 131C may include an electrolyte injection hole 132A into which a sealing plug 133A may be inserted. A vent portion 134A in which a notch 135A is formed may be mounted to the cap plate 131C. The vent portion 134A may seal a vent hole formed in the cap plate 131C. In some examples, the vent portion 134A may be bonded or welded to a peripheral region of the vent hole (region of the cap plate).

The negative and positive terminals 121A and 122A may be electrically connected to a current collector. The current collector may include first and second current collectors 140A and 150A (hereinafter referred to as negative and positive current collectors) that are welded to the first substrate tab 131A and the second substrate tab 132A, respectively. For example, the negative and positive terminals 121A and 122A may be welded to the negative and positive current collectors 140A and 150A. However, the present disclosure is not limited to such an arrangement, and the negative and positive terminals 121A and 122A may be integrally formed with the negative and positive current collectors 140A and 150A.

An insulating member may be mounted between the electrode assembly 110A and the cap plate 131C. The insulating member may include first and second lower insulating members 160A and 170A. Each of the first and second lower insulating members 160A and 170A may be mounted between the electrode assembly 110A and the cap plate 131C.

One end of a separation member may be mounted between the insulating member and each of the negative and positive terminals 121A and 122A so as to face a side surface of the electrode assembly 110A. In this configuration, the separation member may include first and second separation members 180A and 190A. For example, one end of each of the first and second separation members 180A and 190A may be mounted between a respective one of the first and second lower insulating members 160A and 170A and a respective one of the negative and positive terminals 121A and 122A so as to face a side surface of the electrode assembly 110A. As a result, each of the negative and positive terminals 121A and 122A, which are welded to the negative and positive current collectors 140A and 150A, may be coupled to one end of a respective one of the first and second lower insulating members 160A and 170A and to one end of a respective one of the first and second separation members 180A and 190A.

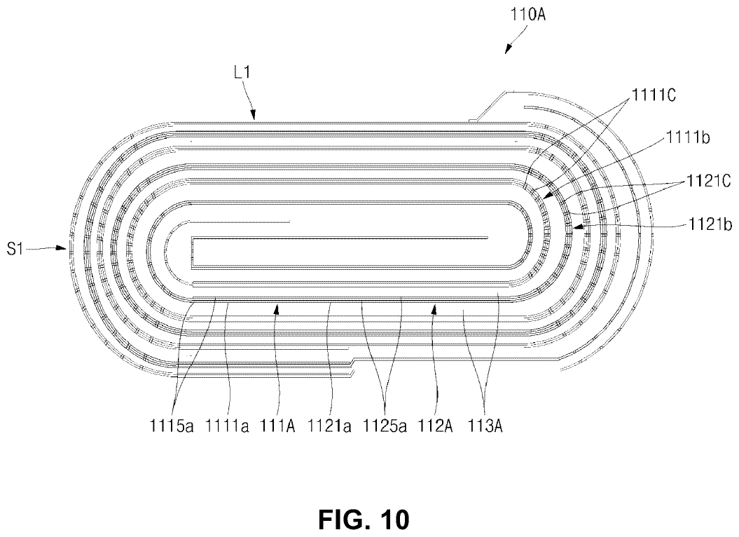

FIG. 10 is a cross-sectional view showing a wound-type electrode assembly 110A according to an embodiment of the present disclosure. A structure including the wound-type electrode assembly will be described with reference to FIG. 10. The wound-type electrode assembly may have a structure in which electrode plates and separators, which are stacked, are continuously wound. Such a configuration is capable of maximizing space utilization.

The electrode assembly 110A according to the present disclosure may include a first electrode plate 111A, a second electrode plate 112A, and a separator 113A interposed between the first and second electrode plates 111A and 112A. The electrode plates 111A and 112A may be stacked and then wound in a predetermined manner, thereby forming a final electrode assembly.

The first electrode plate 111A may include a first conductive substrate 1111a and a first active material layer 1115a coated thereon, and the second electrode plate 112A may also include a second conductive substrate 1121a and a second active material layer 1125a coated thereon. While this configuration is similar to a stacked electrode structure, the wound configuration of the present disclosure may additionally include folding sections 1111b and 1121b.

In detail, the electrode assembly 110A may be wound in a form having long sides L1 and short sides S1. The short sides S1 may be defined as the folding sections 1111b and 1121b. This configuration may include sections that are repeatedly folded during the winding process, and the structure of the folding sections 1111b and 1121b is one of the notable features of the present disclosure.

In the folding sections 1111b and 1121b, a plurality of through-holes 1111c and 1121c may be arranged in a matrix form in order to enhance mechanical flexibility and effectively distribute internal stress. These through-holes 1111c and 1121c may be smoothly deformed during the folding process of the electrode plate, thereby improving the durability of the electrode assembly 110A and minimizing issues such as cracking or interlayer delamination.

Whether active material layers are coated in the folding sections 1111c and 1121c may be varied depending on the particular embodiment. In one embodiment, the first active material layer 1115a may be provided in the folding section of the first electrode plate 111A. In this configuration, the through-holes 1111c may be formed through both the first active material layer 1115a and the first conductive substrate 1111a. In another embodiment, the first active material layer may not be coated in the folding section 1111b. In this configuration, the through-holes 1111c may be formed only through the first conductive substrate 1111a.

Similarly, the second active material layer 1125a may also be provided in the folding section 1121b of the second electrode plate 112A. In this configuration, the through-holes 1121c may be formed through both the second active material layer 1125a and the second conductive substrate 1121a. In a still further embodiment, the second active material layer 1125a may not be formed in the folding section 1121b of the second electrode plate 112A. In this configuration, the through-holes 1121c may be formed only through the second conductive substrate 1121a.

As described above, the through-hole structure of the folding section in the present disclosure may be used in both a stacked-type electrode assembly and a wound-type electrode assembly. The present disclosure is not limited to any specific type of electrode assembly and may be consistently utilized in the processes of manufacturing various types of batteries. According to the present disclosure, even in a wound structure, folding is facilitated while maintaining the mechanical strength of an electrode. There is also enhanced flexibility and design freedom in the battery manufacturing process.

As a result, the wound-type electrode assembly of the present disclosure may improve the durability of the electrode plate, maintain mechanical stability, and facilitate the physical deformation of the folding section, thereby enhancing the performance of the battery.

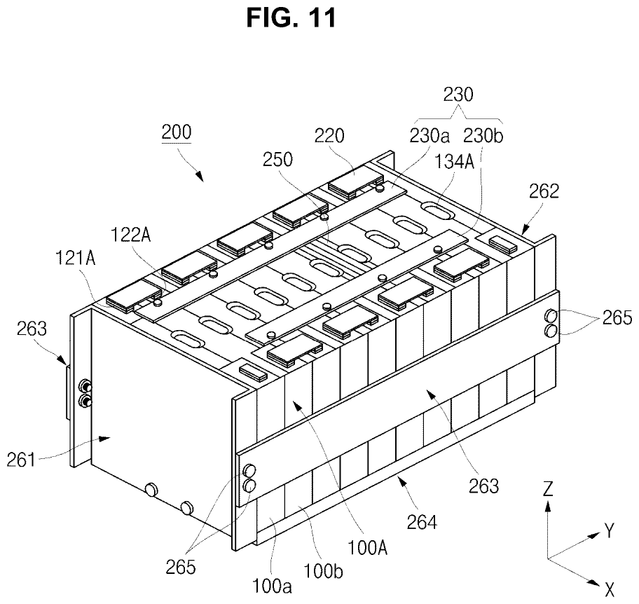

FIG. 11 is a perspective view showing a battery module 200 according to an embodiment of the present disclosure. In the example shown in FIG. 11, the battery module 200 according to the present disclosure includes electrode portions 121A and 122A, a plurality of battery cells 100A arranged in one direction, a connection tab 220 connecting a battery cell 100a to an adjacent battery cell 100b, and a protection circuit module 230 having one end connected to the connection tab 220. The protection circuit module 230 may be a battery management system (BMS). In addition, the connection tab 220 includes a body portion that is in contact with the electrode portions 121A and 122A between neighboring battery cells 100a and 100b and an extension portion that extends from the body portion and is connected to the protection circuit module 230. The connection tab 220 may be a bus bar.

First, as described above, the battery cell 100A may include a battery case, an electrode stack housed in the battery case, and an electrolyte. The electrode stack and the electrolyte react electrochemically to generate energy. One side of the battery cell 100A may be provided with terminal portions 121A and 122A electrically connected to a connection tab 220, and a vent 134A as an exhaust passage for the gas that is generated internally. The terminals 121A and 122A of the battery cells 100A may be a negative electrode terminal 121A and a positive electrode terminal 122B having different polarities, and the terminals 121A and 122A of neighboring battery cells 100a and 100b nay be electrically connected in series or in parallel by the connection tab 220 which will be described below. Meanwhile, the above description was given by way of example of a serial connection, but it is not limited to this structure, and various connection structures may be adopted as needed. In addition, the number and arrangement of battery cells are not limited to the structure shown in FIG. 11 and may be changed as needed.

A plurality of battery cells 100A may be arranged in one direction so that the wide-area surfaces of the battery cells 100A face each other, and the arranged plurality of battery cells 100A may be fixed by housings 261, 262, 263, and 264. The housings 261, 262, 263, and 264 may include a pair of end plates 261 and 262 facing the wide-area surfaces of the battery cell 100A, a side plate 263 connecting the pair of end plates 261 and 262, and a bottom plate 264. The side plate 263 may support the side surface of the battery cell 100A, and the bottom plate 264 may support the bottom surface of the battery cell 100A. In addition, the pair of end plates 261 and 262, the side plate 263, and the bottom plate 264 may be connected by means of a member, such as a bolt 265. In some examples, the bottom plate 264 may include or be referred to as a cooling plate.

The protection circuit module 230 mounts electronic components and protection circuits, and may be electrically connected to the connection tab 220 which will be described below. The protection circuit module 230 may include a first protection circuit module 230a and a second protection circuit module 230b extending at different locations along the direction in which the plurality of battery cells 100A are arranged, where the first protection circuit module 230a and the second protection circuit module 230b are positioned parallel to each other while being spaced apart from each other by a certain distance, and may be electrically connected to the connection tab 220 that is adjacent thereto, respectively. For example, the first protection circuit module 230a is formed to extend from one upper side of the plurality of battery cells 100A along the direction in which the plurality of battery cells 100A are arranged, and the second protection circuit module 230b is formed to extend from the other upper side of the plurality of battery cells 100A along the direction in which the plurality of battery cells 100A are arranged. Here, the second protection circuit module 230b is positioned to be spaced apart from the first protection circuit module 230a by a certain distance with the vent 134A interposed therebetween, but may be arranged parallel to the first protection circuit module 230a. In this way, the two protection circuit modules are arranged in parallel and spaced apart from each other along the direction in which a plurality battery cells are arranged, thereby minimizing the area of a printed circuit board (PCB) that constitutes the protection circuit module. By configuring the protection circuit module as two separate protection circuit modules, an unnecessary area of the PCM can be minimized. In addition, the first protection circuit module 230a and the second protection circuit module 230b may be connected to each other by a conductive connecting member 250. Here, one side of the connecting member 250 is connected to the first protection circuit module 230a, and the other side is connected to the second protection circuit module 230b, thereby achieving an electrical connection can be made between the two protection circuit modules.

The connection may be performed by any one of soldering, resistance welding, laser welding, or projection welding.

In addition, the connecting member 250 may be, for example, an electric wire. In addition, the connecting member 250 may be made of a material having elasticity or flexibility. By means of the connecting member 250, the voltage, temperature, and current of the plurality of battery cells 100A may be checked and managed to be normal. That is, information such as voltage, current, and temperature received by the first protection circuit module from the connection tab that is adjacent thereto and information such as voltage, current, and temperature received by the second protection circuit module from the connection tab that is adjacent thereto may be integrated and managed by the protection circuit module through the connecting member.

In addition, when the battery cell 100A swells, the shock may be absorbed by the elasticity or flexibility of the connecting member 250, thereby preventing the first and second protection circuit modules 230a and 230b from being damaged. In addition, the shape or structure of connecting member 250 are not limited to that shown in FIG. 11.

In this way, since the protection circuit module 230 includes the first and second protection circuit modules 230a and 230b, the area of the PCB constituting the protection circuit module can be minimized, thereby securing a space inside the battery module. This improves work efficiency by facilitating repair when an abnormality is detected in the battery module as well as a fastening work of connecting the connection tab 220 and the protection circuit module 230.

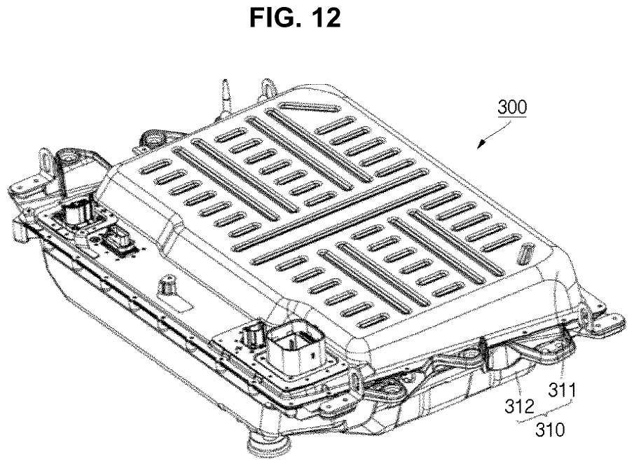

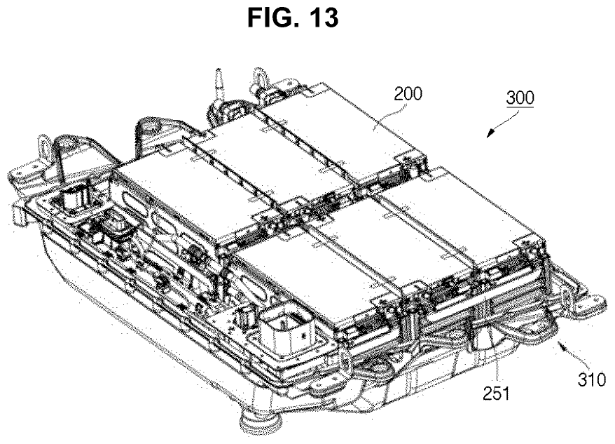

FIGS. 12 and 13 are perspective views showing a battery pack 300 including the secondary battery according to some embodiments. Referring to FIGS. 12 and 13, the battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the FIGS. 12 and 13, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. The vehicle may include a four-wheeled vehicle or a two-wheeled vehicle.

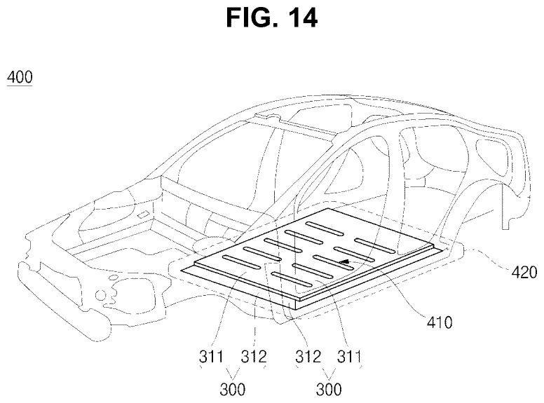

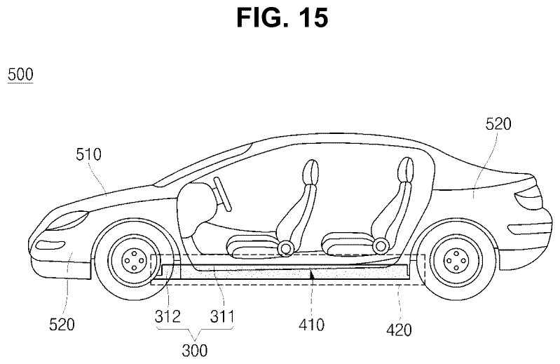

FIGS. 14 and 15 are perspective and side views showing vehicles 400 and 500 including the battery pack 300 according to some embodiments. In FIG. 14, a battery pack 300 may include a battery pack cover 311 (may correspond to the first housing above), which is a part of a vehicle underbody 410, and a pack frame 312 (may correspond to the second housing above) located under the vehicle underbody 410. The pack frame 312 and the battery pack cover 311 may be integrally formed with a vehicle floor 420. The vehicle underbody 410 separates the inside and outside of a vehicle, and the pack frame 312 may be located outside the vehicle.

In FIG. 15, a vehicle 500 may be formed by combining additional parts, such as a hood 510 in front of the vehicle and fenders 520 respectively located in the front and rear of the vehicle to vehicle body parts 400. The vehicle 500 may further include a vehicle floor 420, which is one of the vehicle body parts 400 including the battery pack 300 including the pack frame 312 and the battery pack cover 311.

As is apparent from the above description, according to the present disclosure, the process of stacking the electrode plates may be simplified. In conventional techniques, precise alignment of electrode plates is required during stacking, resulting in additional process steps. In contrast, the present disclosure may simplify the stacking process by employing a plurality of through-holes to form a structure enabling smooth folding. Further, the present disclosure may prevent delamination from occurring during the alignment process, thereby enhancing manufacturing stability.

Further, according to the present disclosure, space utilization may be improved. In conventional stacked structures, a large folding curvature of the electrode plate results in an increased stacking interval. In contrast, the present disclosure may form a folding structure with a minimized interval between the electrode plates. As a result, a greater number of electrode plates may be stacked within a given volume, thereby increasing the storage capacity of the battery. This may contribute to increasing energy density and allow more energy to be stored even in batteries of the same size.

Still further, according to the present disclosure, the durability of the electrode plate may be enhanced. The mechanical strength of the electrode plate may be increased by applying a patterned coating with high binder content to a region in which folding occurs. Compared to a conventional slurry coating method, the method of applying a patterned coating with high binder content may increase the bending resistance of the electrode plate and prevent performance degradation after prolonged use.

As described above, the present disclosure may improve the structural stability of the electrode plate and maximize space utilization while simplifying the battery manufacturing process, thereby enabling the implementation of high-performance batteries. This may enhance battery manufacturing efficiency and enable the production of high-performance batteries.

However, aspects and features of the present disclosure are not limited to those described above, and other aspects and features not mentioned will be clearly understood by a person skilled in the art from the detailed description, described above.

Although aspects of some embodiments of the present disclosure have been described above with limited examples and drawings, embodiments according to the present disclosure are not limited thereto, and various modifications and variations may be made by those skilled in the art in the technical field to which the present invention belongs within the technical idea of embodiments according to the present disclosure.

What is claimed is:

1. An electrode assembly for a secondary battery, the electrode assembly comprising:
a first electrode plate comprising a plurality of folding sections and a plurality of stacked first stacking sections, each of the folding sections connecting two adjacent first stacking sections and each of the folding sections comprising a plurality of through-holes; and
a second electrode plate comprising a plurality of second stacking sections, each second stacking sections being disposed between two adjacent first stacking sections.

2. The electrode assembly as claimed in claim 1, wherein the first electrode plate comprises:
a conductive substrate;
a first active material layer coated on the conductive substrate; and
a second active material layer coated on the first active material layer, and
wherein the first active material layer is coated in the folding sections, and the first and second active material layers are coated in the first stacking sections.

3. The electrode assembly as claimed in claim 2, wherein the first active material layer comprises a first binder, the second active material layer comprises a second binder, and a concentration of the first binder is higher than a concentration of the second binder.

4. The electrode assembly as claimed in claim 3, wherein each of the first and second binders comprises an aqueous binder or an organic binder.

5. The electrode assembly as claimed in claim 3, wherein each of the first and second binders comprises carboxymethyl cellulose (CMC), styrene-butadiene rubber (SBR), polytetrafluoroethylene (PTFE), or polyvinylidene fluoride (PVDF).

6. The electrode assembly as claimed in claim 3, wherein the through-holes formed in each of the folding sections extend through the first active material layer and the conductive substrate.

7. The electrode assembly as claimed in claim 1, wherein the through-holes are formed in triangular, circular, elliptical, square, rectangular, pentagonal, hexagonal, rhombic, or cross shapes, and the through holes are arrayed in a matrix form in each of the folding sections.

8. The electrode assembly as claimed in claim 1, wherein the folding sections and the first stacking sections in the first electrode plate include a Z-shape or an S-shape.

9. The electrode assembly as claimed in claim 1, further comprising a separator interposed between the first stacking sections and the second stacking sections.

10. The electrode assembly as claimed in claim 1, wherein a total area of the through-holes in each of the folding sections is 40% to 90% of an area of each of the folding sections.

11. A secondary battery comprising the electrode assembly as claimed in claim 1.

12. An electrode assembly for a secondary battery, the electrode assembly comprising:
a first electrode plate;
a second electrode plate; and
a separator disposed between the first and second electrode plates,
wherein the first electrode plate, the second electrode plate, and the separator disposed between the first and second electrode plates are wound in a jelly roll form,
wherein at least one of the first electrode plate or the second electrode plate comprises a plurality of folding sections, and each of the folding sections comprises a plurality of through-holes.

13. The electrode assembly as claimed in claim 12, wherein at least one of the first electrode plate or the second electrode plate comprises:
a conductive substrate;
a first active material layer coated on the conductive substrate; and
a second active material layer coated on the first active material layer, and
wherein the first active material layer is coated in the folding sections, and the first and second active material layers are coated in sections other than the folding sections.

14. The electrode assembly as claimed in claim 13, wherein the first active material layer comprises a first binder, the second active material layer comprises a second binder, and a concentration of the first binder is higher than a concentration of the second binder.

15. The electrode assembly as claimed in claim 14, wherein each of the first and second binders comprises an aqueous binder or an organic binder.

16. The electrode assembly as claimed in claim 14, wherein each of the first and second binders comprises carboxymethyl cellulose (CMC), styrene-butadiene rubber (SBR), polytetrafluoroethylene (PTFE), or polyvinylidene fluoride (PVDF).

17. The electrode assembly as claimed in claim 14, wherein the through-holes formed in each of the folding sections extend through the first active material layer and the conductive substrate.

18. The electrode assembly as claimed in claim 12, wherein the through-holes are formed in triangular, circular, elliptical, square, rectangular, pentagonal, hexagonal, rhombic, or cross shapes, and the through-holes are arrayed in a matrix form in each of the folding sections.

19. The electrode assembly as claimed in claim 12, wherein the electrode assembly is wound in a form having long sides and short sides.

20. The electrode assembly as claimed in claim 12, wherein a total area of the through-holes in each of the folding sections is 40% to 90% of an area of each of the folding sections.

21. A secondary battery comprising the electrode assembly as claimed in claim 12.
